(19) United States
(12) Patent Application Publication
(10) Pub. No.: US 2007/0050435 A1
(43) Pub. Date: Mar. 1, 2007

(54) Leading-Zero Counter and Method to Count Leading Zeros

(76) Inventors: Christian Jacobi, Schoenaich (DE); Silvia Mueller, Altdorf (DE); Jochen Preiss, Boeblingen (DE); Kai Weber, Boeblingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/459,663

(22) Filed: Jul. 25, 2006

(30) Foreign Application Priority Data
Aug. 30, 2005 (EP) 05107934.1

(51) Int. Cl. G06F 15/00

(52) U.S. Cl. 708/200

(57) ABSTRACT

The present invention relates to a circuit comprising a Leading Zero Counter (LZC) sub-circuit driving a second sub-circuit, like a shifter or arbiter. Shifter circuits or arbiter circuits operating with fewer stages than before have a smaller delay since every stage can select between more than two inputs. This reduces the overall delay of the shifter, arbiter, etc. But for state-of-the art binary LZC circuits this requires a complex recoding between LZC and shifter circuit. In order to provide an improved leading zero circuit having an output which allows a simpler control of a post-connected sub-circuit having two or more stages and having at least one stage with three or more inputs, it is proposed to provide a LZC circuitry providing an output consisting of two or more unary encoded substrings. This removes the requirement for a recoder between LZC and shifter.

### BACKGROUND OF THE INVENTION

1. Field of the Invention

The present invention relates to a leading-zero counter, a method to count leading zeros and a corresponding computer program product.

2. Description and Disadvantages of Prior Art

Current circuit technologies allow building gates with more than two inputs that have only slightly higher delay compared to gates with only two inputs. Especially multiplexers with many inputs and low delay can be built with current circuit technologies, e.g., using transmission gates. Using these multiplexers one can build for example shifter circuits or arbiter circuits with fewer stages than before since every stage can select between more than two inputs. This reduces the overall delay of the shifter, arbiter, etc.

The control wires for each stage of such “few-stage” circuits usually need to be hot-one-encoded. This means that exactly one of the control wires carries a ON-signal (high), and the others an OFF-signal (low). A hot-one-encoded signal string consisting of N signals (0, . . . , N-1) is called N-bit digit in the following.

In a case of a 4-input shifter stage for example a 4-bit digit is needed. The location of the ON-signal wire within the 4-bit digit indicates directly the shift amount. Thus, if the 0^{th} wire is ON, the shift amount will be 0, if the 2^{nd} wire is ON, the shift amount will be 2, etc. In an arbiter circuit a respective input is selected from the total number of input wires.

With reference to the focus of the present invention there is a close relationship between a leading zero counter (LZC) and such shifter within a floating point unit, as the mantissa of a floating point operand must be shifted according to the result calculated by the leading zero counter. Thus, the present invention focuses on circuits comprising an LZC sub-circuit which controls a further sub-circuit, such as a shifter sub-circuit, arbiter, etc.

With reference to FIG. 1 prior art leading zero counters 10 return the number of leading zeros in a binary encoding. Thus for example if the two lower bits of the prior art LZC output are “10” ( binary for decimal “2”) on two wires, this must be recoded to “0010” in the hot-one-format (counting the wire index from left to right).

Thus, in order to control the before-mentioned “few stage” shifter 12 with the output of a prior art leading zero counter, the output of the LZC 10 must be recoded as depicted in FIG. 1 with a recoder stage 14. If the number of inputs of each shifter stage is a power-of-two (i.e., 2ˆk) the recoding can be done using standard decoders using k input bits each. If the number of inputs of a shifter stage is not a power of two, this recoding is non-trivial. This represents a severe constraint in relation to the fact that in many applications the design of the LZC sub-circuit is closely adapted to the design of the sub-circuit, e.g., a shifter controlled by the LZC.

Thus, if for example a shifter sub-circuit may be assumed to have its best performance when having a design implementing a first 3-input stage, a second 4-inputs stage, and a third 5-inputs stage, then the driving prior art LZC sub-circuit should be implemented with a respective recoder circuitry 14, which causes quite a lot of design work for implementing it, and which involves a considerable delay during operation thereof.

### OBJECTIVES OF THE INVENTION

It is thus an objective of the present invention to provide an improved leading zero circuit having an output which allows a simpler control of a post-connected sub-circuit having two or more stages and having at least one stage with three or more input wires.

### SUMMARY AND ADVANTAGES OF THE INVENTION

This objective of the invention is achieved by the features stated in enclosed independent claims. Further advantageous arrangements and embodiments of the invention are set forth in the dependent claims. Reference should now be made to the appended claims.

According to the broadest aspect of the invention a leading zero counter (LZC) circuit is disclosed that is characterized by a circuitry providing an output that defines the number of leading zeros in a format consisting of two or more unary encoded substrings, wherein at least one substring comprises at least three bits, which output preferably consists of three or more digits in the above described sense, i.e., a hot-one-encoded signal string consisting of N (N=3, 4, . . . ) signals.

In a simple case defining the minimal requirements (6 inputs) such an output may look like:

First substring: “001” for hot-encoding the bit 2 in an N=3 bit signal,

Second substring: “10” for hot-encoding the bit 0 in an N=2 bit signal.

In a more realistic case with 27 inputs the output may look like:

First substring: “010” for hot-encoding the bit 1 in an N=3 bit signal,

Second substring: “001” for hot-encoding the bit 2 in an N=3 bit signal,

Third substring: “100” for hot-encoding the bit 0 in an N=3 bit signal.

These substrings would encode the number (1*3ˆ²)+(2*3ˆ¹)+(0*3ˆ⁰)=15.

This feature is the main feature for an inventive concept, which allows an easy adaptation of the LZC circuit to any particular design of a post-connected multiple stage sub-circuit, which may have basically any number of input wires in any stage. For example, a first stage having 3 inputs, a second having 5, and a third having 7 inputs, to denote a quite “exotic” example.

Preferably, if the output of the above circuitry consists of only one digit, it is built using a core circuit structure with N ( N=3, 4, . . . ) inputs, that further comprises:
a) an not-all-zero calculation element receiving the N inputs and calculating a not-zero-signal, which is ON when not all inputs are OFF, e.g. a OR gate, and
b) a leading zero calculation sub-circuit driven by said N inputs and generating N-bit leading zero output indicating the location of the highest-order ONE-bit in the input bit string.

This core structure can be used in a recursively repeated form to construct a multiple stage LZC circuit with an output that consists of i digits (i>1). This recursively repeated circuit structure, comprises preferably:
a) a next-lower recursive stage with P inputs calculating a not-zero-signal and a P-bit leading-zero output consisting of i-1 digits,
b) wherein the next-lower recursive stage is switched N-times in parallel for receiving N bundles of P inputs,
c) a core circuit structure with N inputs comprising the not-all-zero calculation element and the leading zero calculation sub-circuit as mentioned above,
d) wherein the inputs of the core circuit structure are connected to the N not-zero-signal outputs of the next-lower recursive stages,
e) a multiplexer-element the data input of which is connected to the N P-bit leading-zero outputs of the next-lower recursive stages and which is select-controlled by the output of the leading zero calculation sub-circuit of the core circuit structure,
f) a not-all-zero output derived from the not-all-zero output of the core circuit structure, and
g) a N+P bit leading-zero output consisting of i digits computed by concatenating the N-bit leading-zero outputs of the not-all-zero output of the core circuit structure and the P-bit output of the multiplexer-element.

It should be noted that P may be equal to N, but in general can be freely selected independently from N. This allows to construct an LZC output bit string, of which the MSB string is an N-bit digit, dedicated to feed for example a first shifter stage, the next significant bit string is a M-bit digit to feed a second stage of a shifter, and so on. This may end up in any number of stages with any individual digit width. This option enables for an easy adaptation of the LZC to any constraint given by the design of the post-connected circuit, as e.g. the before-mentioned shifter.

The above LZC circuit can be preferably applied in a circuit comprising this LZC circuit as a sub-circuit and driving a second sub-circuit with the outputs of the LZC sub-circuit, wherein:
a) the LZC circuit provides an output string consisting of two or more digits,
b) the driven circuit has input ports for receiving the output string as an input.

This saves the above-mentioned re-coding in a recoder (FIG. 1) from a binary format to the required hot-one encoded format.

When the driven circuit has a number of stages which is equal to the number of hierarchy levels of the driving LZC circuit, and the bit width of a respective driven circuit stage coincides with the width of the leading-zero calculation sub-circuit of the core circuit structure in the respective LZC circuit level, then a fast implementation is provided.

The basic advantages are as follows: First, the delay of the prior art decoder in FIG. 1 is no longer necessary. Second, the existing “few stage” technology implementing a lower number of stages then traditionally done before can be exploited better: If a certain technology has the best performance (trade-off between delay of each stage vs. number of shifter-stages), this optimum (say 3-port-multiplexers per stage) can be chosen freely without being restricted to powers-of-two for the width of each stage. Note that the same width of the multiplexer is used inside the shifter and inside the LZC.

Both advantages speed up the LZC and the shifter; both components are often timing-critical in floating-point-designs, for example. Additionally, the leading-zero-counter eases the use of such shifters for which the width of the multiplexers is not a power-of-two.

### BRIEF DESCRIPTION OF THE DRAWINGS

The present invention is illustrated by way of example and is not limited by the shape of the figures of the drawings in which:

FIG. 1 is a schematic circuit diagram illustrating a prior art leading zero counter design needing a decoder (re-decoder) in order to control the shifter with more than two inputs per stage;

FIG. 2 is a schematic circuit diagram illustrating a leading zero counter design according to the invention in a rough overview form which allows to directly control a shifter with more than two inputs per stage;

FIG. 3 is a circuit diagram illustrating the lowest recursive stage, i.e. the core logic of a LZC circuit with a 3-bit digit leading zero output output according to a preferred embodiment of the invention;

FIG. 4 is a circuit diagram illustrating the recursive construction of a LZC circuit with an leading zero output consisting of 3-bit digits;

FIG. 5 is a schematic block diagram illustrating an example of a 27-bit leading zero counter controlling a 27-bit, 3-stage shifter with 3-bit digit control signals per stage.

### DETAILED DESCRIPTION OF THE PREFERRED EMBODIMENT

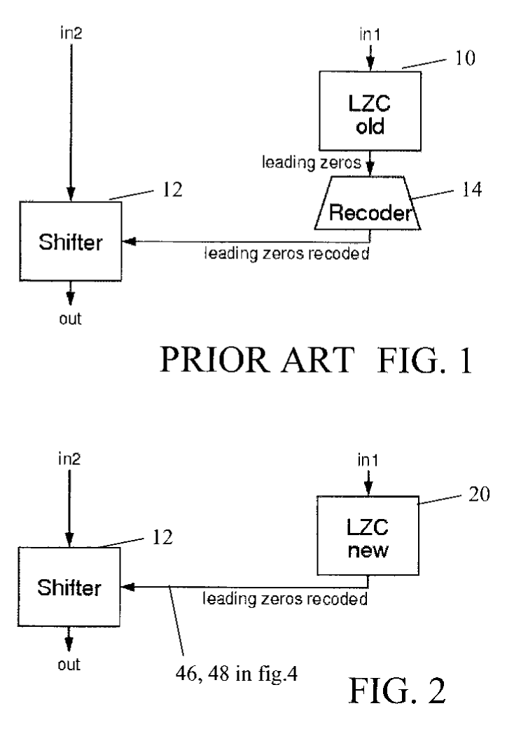

With general reference to the figures and with special reference now to FIG. 2 the LZC circuit 20 according to this embodiment controls a shifter 12 as described in FIG. 1 with the new feature that a recoder 14 is not required, as the inventional LZC circuit denoted as “new” generates the hot-one encoded format in its output bit string.

As an instructive example, a 3-stage shifter 12 may be assumed, which has 3 input bits in each stage, which are all delivered by the LZC circuit. The shifter 12 controlled by the leading zero counter (LZC) 20 thus selects between three inputs in each stage. Thus, one stage shifts by 0, 1, or 2; a second stage shifts by 0, 3, or 6; and a third stage shifts by 0, 9, or 18, and so on. The leading zero counter then must compute 3-bit digit control signals per stage.

The first 3-bit digit defines whether the input should be shifted by 0, 1, or 2; another 3-bit digit defines whether the input should be shifted by 0, 3, or 6 and so on. It should be noted that the sum of the selected shift distances must equal the number of leading zeros of the input to the LZC.

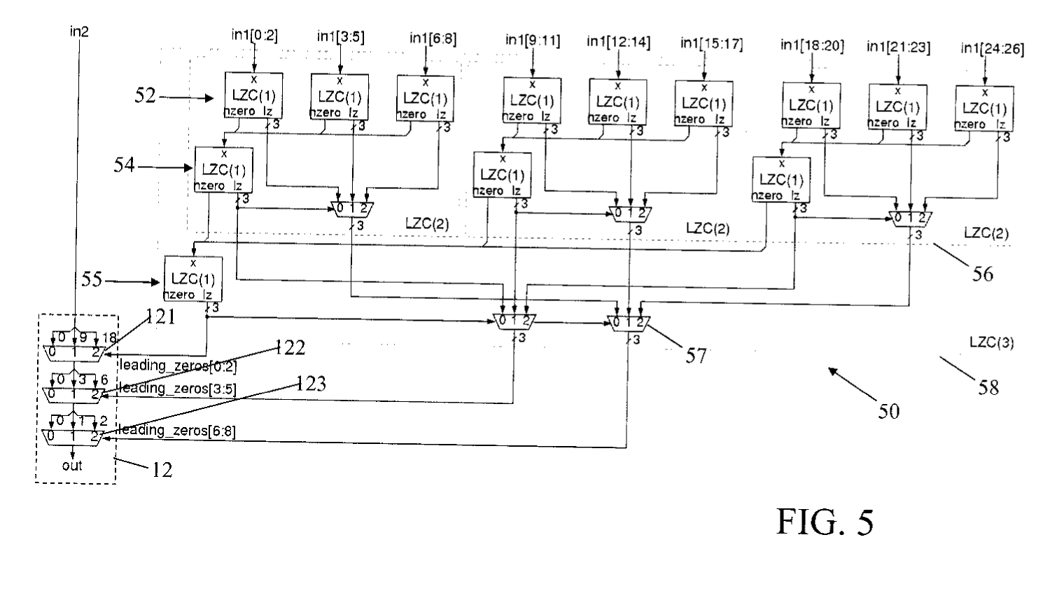

Details how the bit string between LZC 20 and shifter 12 is structured and which substring is fed to which shifter stage are described also later with respect to FIG. 5.

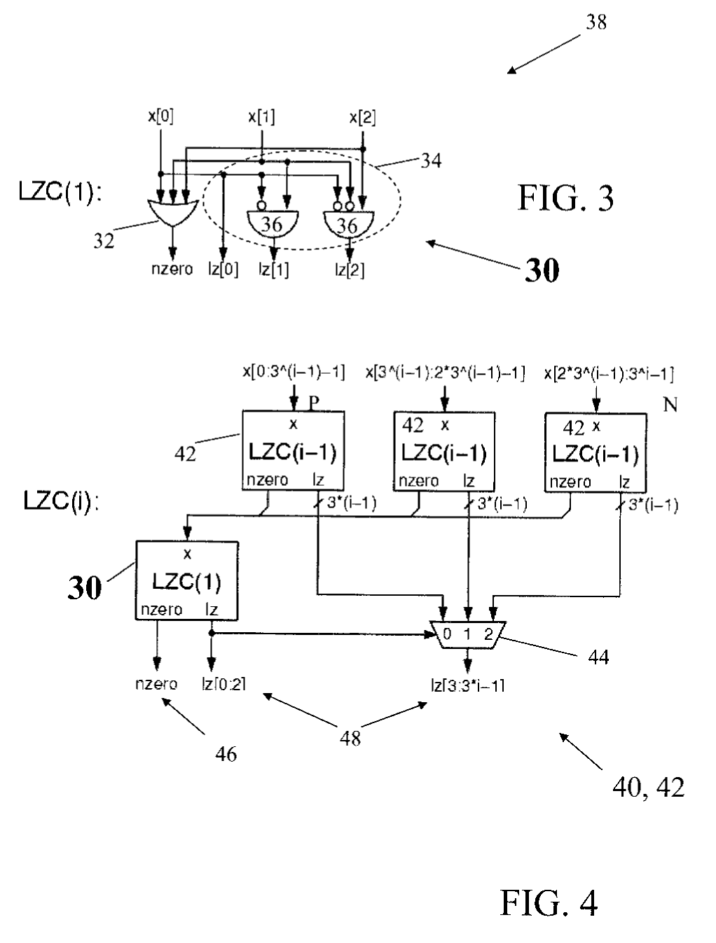

The basic functions of a preferred LZC embodiment are described next with reference to FIGS. 3, 4, and 5.

First, with special reference to FIG. 3 the inner core 30 of the described LZC circuit 20 receives three (N=3) bits at its input, i.e., x(0), x(1) and x(2). The core 30 comprises a 3-inputs OR gate 32 connected to the three inputs and computing the output “nzero”.

In a sub-circuit 34 the signal x(0) is fed directly through as output 1z(0). Further, the sub-circuit 34 comprises N-1=2 AND gates 36-1 and 36-2 computing the outputs 1z(1) and 1z(2) for the purpose of leading zero calculation. AND gate 36-1 has the negation of x(0) and x(1) as inputs. AND gate 36-2 has the negation of x(0) and of x(1) and x(2) as inputs. They operate on x such that 36-1 outputs an ON-signal, if x(0) is OFF and x(1) is ON, and 36-2 outputs an ON-signal if x(0) and x(1) are OFF but x(2) is ON.

The core 30 thus computes two types of outputs denoted as “1z” and “nzero” from the input “x”. The output “nzero” is ON, or “active” if the “x” input bit string does not consist of zeros only. This signal is preferably used for an advantageous recursive design of the LZC. The output “1z” encodes the number of leading zeros of “x” in the bits 1z(0), 1z(1), 1z(2). Thus, OR gate 32 acts as not-all-zero calculation element, and sub-circuit 34 acts as leading zero calculation sub-circuit.

If the LZC circuit 20 controls a shifter with a number of i stages having each j=3 inputs, then the LZC circuit 20 must compute i j-bit digits. Thus the output 1z consists of j*i bits where the last j bits are the least significant digit, i.e., the digit that selects between the shift distances 0, 1, and 2. Of course, i and j can be varied independently from each other, e.g i=4, j=5, etc.

As j=3 in this example, an LZC circuit 20, which computes i 3-bit digits is called LZC(i) in the following.

Having introduced the core 30 of the LZC circuit the construction of an LZC(1) is straight-forward as illustrated in FIG. 4. The output “nzero” of LZC(1) 30 is active if one of the inputs “x[0:2]” is ON. This output “1z” consists of only one digit. The bit 0 of this digit is active if the input bit “x[0]” is 1, i.e., the input has 0 leading zeros. The bit 1 is active, if “x[0]” is 0, but x[1] is 1, i.e., the input has 1 leading zero. The bit 2 is active, if “x[0]” and “x[1]” are 0, and “x[2]” is 1, i.e., the input has 2 leading zeros.

An LZC(i) for i>1 can be built from three LZC(i-1) 42 and one LZC(1) 30, see FIG. 4. The three LZC(i-1) circuits each operate on a third of the input bus “x”. The outputs of these LZC(i-1) indicate if the corresponding part of the input bus does not consist of zeros only and encode the number of leading zeros of the part. The LZC(1) uses the “nzero” outputs of the LZC(i-1) as inputs. Thus, if the output “1z[k]” of the LZC(l) is active (for 0<=k<=2), the input bus “x” of the overall circuit LZC(i) has between k*3ˆ(i-1) and (k+1)*3ˆ(i-1)-1 leading zeros. Hence the output “1z” of the LZC(1) can be used as most significant digit (bits 0 to 2) of the output bus “1z” of the LZC(i). The lower order digits must be the output “1z” of the LZC(i-1) which uses the first part of the input bus that does not consist of zeros only as input. Thus, the lower order digits can be computed using a three-port multiplexer 44 that uses the “1z” outputs of the LZC(i-1) as inputs and is controlled by the output “1z” of the LZC(1). The overall “nzero” output is the “nzero” output of the LZC(1).

A person skilled in the art will appreciate the recursive principle of the invention which may be understood by combining the elements shown in FIG. 3 and FIG. 4 multiple times:

The circuits 42 in FIG. 4 build up the next-lower recursive stage and produce inputs for the higher-level circuit shown in FIG. 4. The circuits 42 can be thought to be the circuit depicted in FIG. 4 in total (by replacing i with i-1 in the figure). This principle can be continued until i=1, i.e. the lowest level of the recursion is reached. In this case of the lowest-level recursive stage, the circuit of FIG. 3 must be inserted instead of the circuit of FIG. 4.

FIG. 5 gives an example of a 27-bit leading zero counter 50 that controls a shifter 12 with three inputs per stage. The leading zero counter 50 and the shifter 12 consist of three stages. The 27 input bits of the leading zero counter 50 are split into 9 blocks of 3 bits each. These bit blocks are fed into nine 3-bit leading zero counters LZC(1) which are depicted in the top “LZC-row” 52. This is the inner hierarchy level.

Respective three blocks in LZC-row 54 form the input of the 9-bit leading zero counters LZC(2) which are within frame 56, and form the middle hierarchy level.

The overall 27 bit leading zero counter LZC(3) depicted with reference sign 58 is built using 3 LZC(2) outputs as inputs at multiplexer 57 taking into account all 27 input bits.

Since the most significant outputs of the leading zero counter (bit 0 to 2) are least timing critical, they control the first stage 121 of the shifter. Thus, this shifter stage selects between shift distances of 0, 9, and 18. The next stage 122 uses the bits 3 to 5 of the leading zero counter output and therefore selects between shift distances of 0, 3, and 6. The least significant outputs of the leading zero counter (bits 6 to 8) select between shift distances of 0, 1, and 2 in shifter stage 123.

It should be appreciated further that the design of the LZC circuit 20 is not limited to the controlling of a shifter or arbiter. This design can be easily extended such that it counts leading ones, trailing zeros, or trailing ones. In order to do that one just needs to modify the polarity or the numbering of the inputs.

Or, it may be extended that it uses different encodings for the digits than the unary hot-one-encoding, or hot-zero-encoding, such as half-unary-encoding, etc.

Or, that a binary encoding is used for a digit with width N=2 by dropping the bit 0 of the digit,

Or, that the polarity of any intermediate signals is modified, e.g., using an all-zero signal instead of a not-all-zero signal,

Or, that the width of the digits is different to three, as it was shown in the figures. This was already described with examples i and j further above.

Further, the width of the digits is not restricted to be the same for all stages, as it was mentioned further above.

The present invention can be realized in hardware, software, or a combination of hardware and software. A leading zero detection tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following
a) conversion to another language, code or notation;
b) reproduction in a different material form.

1. A leading zero counter (LZC) circuit, characterized by a circuitry providing an output that defines the number of leading zeros in a format consisting of two or more unary encoded substrings, wherein at least one substring comprises at least three bits.

2. The LZC circuit according to claim 1, having a circuit structure with N (N=3, 4, . . . ) input bits, and further comprising:
a) a first not-all-zero calculation element receiving the N input bits and calculating a not-zero-signal, which is ON when not all input bits are OFF,
b) a leading zero calculation sub-circuit driven by said N input bits and generating a N-bit leading zero output indicating the location of the highest-order ONE-bit the input hit string.

3. The LZC circuit according to claim 1, wherein said first circuit element comprises an OR-gate receiving said N inputs.

4. The LZC circuit according to claim 1, wherein said leading zero calculation sub-circuit (34) comprises at least a number of (N-1) AND gates (36).

5. The LZC circuit according to claim 1, having a recursively repeated circuit structure, comprising:
a) a next-lower recursive stage with P inputs calculating a not-zero-signal and a P-bit leading-zero output as mentioned above,
b) wherein the next-lower recursive stage is switched N-times in parallel for receiving N bundles of P inputs,
c) a core circuit structure with N inputs comprising said not-all-zero calculation element and said leading zero calculation sub-circuit,
d) wherein the inputs of the core circuit structure are connected to the N not-zero-signal outputs of the next-lower recursive stages,
e) a multiplexer-element the data input of which is connected to the N P-bit leading-zero outputs of the next-lower recursive stages and which multiplexer element is select-controlled by the output of the leading zero calculation sub-circuit of the core circuit structure,
f) a not-all-zero output derived from the not-all-zero output of the core circuit structure, and
g) a N+P bit leading-zero output computed by concatenating the N-bit leading-zero outputs of the not-all-zero output of the core circuit structure and the P-bit output of the multiplexer-element.

6. A circuit comprising a LZC sub-circuit according to claim 1, driving a second sub-circuit with the outputs of the LZC sub-circuit,
characterized by:
a) the LZC circuit providing an output consisting of two or more substrings with a unary encoding,
b) the driven circuit having input ports for receiving the unary encoded substrings as an input, in order to enable the output of the LZC circuit not having to be re-coded in order to be usable by the driven, second circuit.

7. The circuit according to claim 6, wherein
a) the driven circuit has a number of stages which is equal to the number of hierarchy levels of the driving LZC circuit, and
b) the bit width of a respective driven circuit stage coincides with the number of output bits in a respective LZC circuit level.

8. The circuit according to claim 6, wherein said second circuit is a shifter circuit.

9. The circuit according to claim 6, wherein said second circuit is an arbiter circuit.

10. A method for counting leading zeros contained in an input bit string of a leading zero counter (LZC) circuit,
comprising the step of:
providing an output that defines the number of leading zeros in a format consisting of two or more unary encoded substrings, wherein at least one substring comprises at least three bits.

11. The method according to claim 10, using a circuit structure with N (N=3, 4, . . . ) input bits, and further comprising the steps of:
a) receiving the N input bits in a first not-all-zero calculation element and calculating a not-zero-signal, which is ON when not all input bits are OFF,
b) driving a leading zero calculation sub-circuit with said N input bits and generating a N-bit leading zero output indicating the location of the highest-order ONE-bit the input bit string.

12. The method according to claim 10, wherein said first circuit element comprises an OR-gate receiving said N inputs.

13. The method according to claim 11, wherein said leading zero calculation sub-circuit comprises at least a number of (N-1) AND gates.

14. The method according to claim 10, using a recursively repeated sequence of steps, comprising the steps of:
a) calculating a not-zero-signal and a P-bit leading-zero output by a next-lower recursive stage with P inputs,
b) receiving N bundles of P inputs by the next-lower recursive stage switched N-times in parallel,
c) using a core circuit structure with N inputs comprising said not-all-zero calculation element and said leading zero calculation sub-circuit,
d) using the inputs of the core circuit structure connected to the N not-zero-signal outputs of the next-lower recursive stages,
e) using a multiplexer-element the data input of which is connected to the N P-bit leading-zero outputs of the next-lower recursive stages and
select-controlling said multiplexer element by the output of the leading zero calculation sub-circuit of the core circuit structure,
f) using a not-all-zero output derived from the not-all-zero output of the core circuit structure, and
g) computing a N+P bit leading-zero output by concatenating the N-bit leading-zero outputs of the not-all-zero output of the core circuit structure and the P-bit output of the multiplexer-elemen.

15. A method for operating a LZC sub-circuit according to claim 1, comprising the step of driving a second sub-circuit with the outputs of the LZC sub-circuit,
characterized by the steps of:
a) providing an output consisting of two or more substrings with a unary encoding by the LZC circuit,
b) using input ports of the driven circuit for receiving the unary encoded substrings as an input, in order to enable the output of the LZC circuit not having to be re-coded in order to be usable by the driven, second circuit.

16. The method according to claim 15, comprising the steps of:
a) using the driven circuit with a number of stages which is equal to the number of hierarchy levels of the driving LZC circuit, and
b) using a bit width of a respective driven circuit stage coinciding with the number of output bits in a respective LZC circuit level.

17. The method according to claim 15, wherein said second circuit is a shifter circuit.

18. The method according to claim 17, wherein said second circuit is an arbiter circuit.

19. A computer program product for counting leading zeros contained in an input bit string thereof, the program product having a functional program component providing an output that defines the number of leading zeros in a format consisting of two or more unary encoded substrings, wherein at least one substring comprises at least three bits.

20. The computer program product having functional components for performing the method according to claim 19.
